(19) United States
(12) Patent Application Publication
(10) Pub. No.: US 2013/0053248 A1
(43) Pub. Date: Feb. 28, 2013

(54) PESTICIDAL COMPOSITIONS WITH ENHANCED ACTIVE INGREDIENT RETENTION IN PEST CONTROL ZONES

(71) Applicants: John M. Atkinson, Zionsville, IN (US); Lei Liu, Carmel, IN (US); Maria E. Rodriguez Rosas, Carmel, IN (US); Richard K. Mann, Franklin, IN (US); Raymond E. Boucher, JR., Lebanon, IN (US); David G. Ouse, Indianapolis, IN (US); Joey D. Cobb, Noblesville, IN (US); James M. Gifford, Lebanon, IN (US)

(72) Inventors: John M. Atkinson, Zionsville, IN (US); Lei Liu, Carmel, IN (US); Maria E. Rodriguez Rosas, Carmel, IN (US); Richard K. Mann, Franklin, IN (US); Raymond E. Boucher, JR., Lebanon, IN (US); David G. Ouse, Indianapolis, IN (US); Joey D. Cobb, Noblesville, IN (US); James M. Gifford, Lebanon, IN (US)

(73) Assignee: DOW AGROSCIENCES LLC, Indianapolis, IN (US)

(21) Appl. No.: 13/594,603

(22) Filed: Aug. 24, 2012

Related U.S. Application Data
(60) Provisional application No. 61/527,561, filed on Aug. 25, 2011.

(51) Int. Cl. A01N 25/26; A01P 7/04; A01P 9/00; B05D 7/00; A01P 5/00; A01P 11/00; A01P 13/00; A01P 1/00; A01P 15/00

(52) U.S. Cl. 504/337; 424/419; 424/408; 427/212

(57) ABSTRACT

This disclosure concerns the control of the retention and/or persistence of a biologically active compound (e.g., a pesticide) in soil. In some embodiments, the use of polymer-coated particles comprising a biologically active compound leads to increased persistence of the compound in a target zone to which a composition comprising the particles is applied.

### CROSS-REFERENCE TO RELATED APPLICATION

This application claims the benefit of U.S. Provisional Patent Application Ser. No. 61/527,561, filed Aug. 25, 2011, the disclosure of which is hereby incorporated herein in its entirety by this reference.

### TECHNICAL FIELD

The present disclosure relates to compositions and methods for the application of chemicals (for example, pesticides and herbicides) to soil. In some embodiments, this disclosure relates to compositions and methods that may increase the retention of a chemical in an area of soil to which the chemical is applied. Particular embodiments include micronized solid active chemicals that have been coated with polymers, for example, via a spray-dry process.

### BACKGROUND

Particulate chemicals in water can move through soil, either horizontally or vertically, depending on water movement and the physical/chemical properties of the particle and soil. Soil is made up of different size particles that do not fit together tightly; i.e., there is “soil pore space” between the soil particles. Categories of soil pore spaces include mesopores, which are filled with water at field capacity and function as water storage pores for plant growth. Mesopores vary in size, typically ranging from 0.3 to 200 micrometers (μm, or microns) and distribution. The size and distribution of mesopores is dependent on soil type and structure. Other soil pore types include macropores (typically >200 microns), which are pores that are too large to have any water capillary action, and micropores (typically <0.3 microns), which are too small for plants to use. Encyclopedic Dictionary of Hydrogeology, Eds. Poehls and Smith, 2009, Academic Press, New York, pp. 270-1.

The incorporation of active materials and chemicals in soil is important in a variety of contexts. For example, controlling pest and weed populations by the application of pesticide and/or herbicide compositions directly to the soil as a pre-emergence application prior to weed emergence is essential to modern agriculture. Unfortunately, many active chemical formulations lose their efficacy relatively soon after their application for many reasons. Among the factors known to influence the persistence of pesticides, the chemical stability, volatility, and solubility in plants have long been thought to be the most important. Edwards (1975) Pure and Applied Chemistry 42(1/2):39-56. When a pesticide is applied to a crop or soil, it moves from one part of the system to another, and is ultimately degraded in situ or moved out of the system. It is important to control these processes, because pesticides that move to other systems will not satisfy their intended purpose and may damage the environment. One route for reducing the activity of an active ingredient is movement through the soil following irrigation or rainfall, removing the active ingredient from the zone of weed emergence. A pesticide can disappear from soil, for example, by volatilization, leaching, surface run-off, or uptake by plants. Chemical residues that remain in plants or soil may be metabolized, but often, for persistent pesticides, these residues represent only a small proportion of the whole.

### BRIEF SUMMARY OF THE DISCLOSURE

Disclosed herein are methods and compositions that take advantage of the finding that polymer-coating of a particle comprising a solid active chemical dramatically reduces disappearance of the active chemical from a zone of soil to which the coated chemical is applied. In particular examples, polymer-coated chemical particles exhibit increased persistence in a zone of soil (e.g., a target zone to which the coated particles are applied by spraying). Through increased persistence, a polymer-coated particle comprising a pesticide may provide increased control of susceptible pests. Thus, in embodiments, manufacture and/or use of polymer-coated particles comprising an active chemical increases the amount of the active chemical that will stay in a target zone (e.g., a weed germination zone), and reduces the movement of the active chemical out of the target zone, for example, due to leaching or water movement.

In some embodiments, a polymer-coated particulate composition comprising a biologically active compound is provided. In particular embodiments, a polymer-coated particle may be at least about 0.1 μm in diameter; at least about 1.0 μm in diameter; at least about 20 μm in diameter; at least about 30 μm in diameter; at least about 50 μm in diameter; at least about 75 μm in diameter; and at least about 100 μm in diameter (e.g., approximately 100 μm in diameter). In particular embodiments, a polymer-coated particulate composition may comprise combinations, mixtures, and/or suspensions of particles having any and/or all of these diameters. For example, a polymer-coated particulate composition may comprise a plurality of polymer-coated particles, wherein essentially all of the polymer-coated particles are between 0.1 and 100 μm in diameter (e.g., between 1.0 and 30 μm in diameter). In some embodiments, the coating of a polymer-coated particulate composition may comprise any oil-based polymer (e.g., a latex polymer).

In particular embodiments, a polymer-coated particle comprising a biologically active compound may consist essentially of the biologically active compound, or consist of the biologically active compound. In further embodiments, a polymer-coated particle may comprise a biologically active compound as part of a composition that is capable of maintaining solid form at a particular temperature (e.g., 30° C., and 50° C.). In these and further embodiments, a biologically active compound may be non-solid (e.g., a liquid and a melted wax) and be comprised in a solid composite composition that also comprises a carrier (e.g., a silica carrier).

In some embodiments, a polymer-coated particulate composition comprising a biologically active compound according to the invention may persist longer in a target zone to which the composition is applied than a non-coated particulate composition comprising the same compound. Thus, in particular examples, a polymer-coated particulate composition may exhibit reduced disappearance (e.g., reduced volatilization, leaching, surface run-off, or uptake by plants) than a non-coated particulate composition comprising the same compound.

Thus, also disclosed herein are methods for decreasing the rate at which a biologically active compound disappears from a target zone, as well as methods for increasing the persistence of a biologically active compound in a target zone. In some embodiments, a method may comprise applying a polymer-coated particulate composition comprising a biologically active compound to the target zone. In particular embodiments, a polymer-coated particulate composition comprising a biologically active compound may be applied to a target zone as part of one of many available formulation types available to those of skill in the art (e.g., as an aqueous suspension). In particular examples, a polymer-coated composition may be applied by broadcast spraying.

The foregoing and other features will become more apparent from the following detailed description of several embodiments, which proceeds with reference to the accompanying figures.

### BRIEF DESCRIPTION OF THE FIGURE

FIG. 1 includes data showing the average control (%) of CAPBP (Capsella bura-pastoris (Shepherd's purse)) 28 days after application of several polymer-coated propyzamide formulations (Compositions #8 and #10, respectively, and a control non-coated propyzamide formulation (Kerb 50WP). Data were collected for three application rates of each formulation.

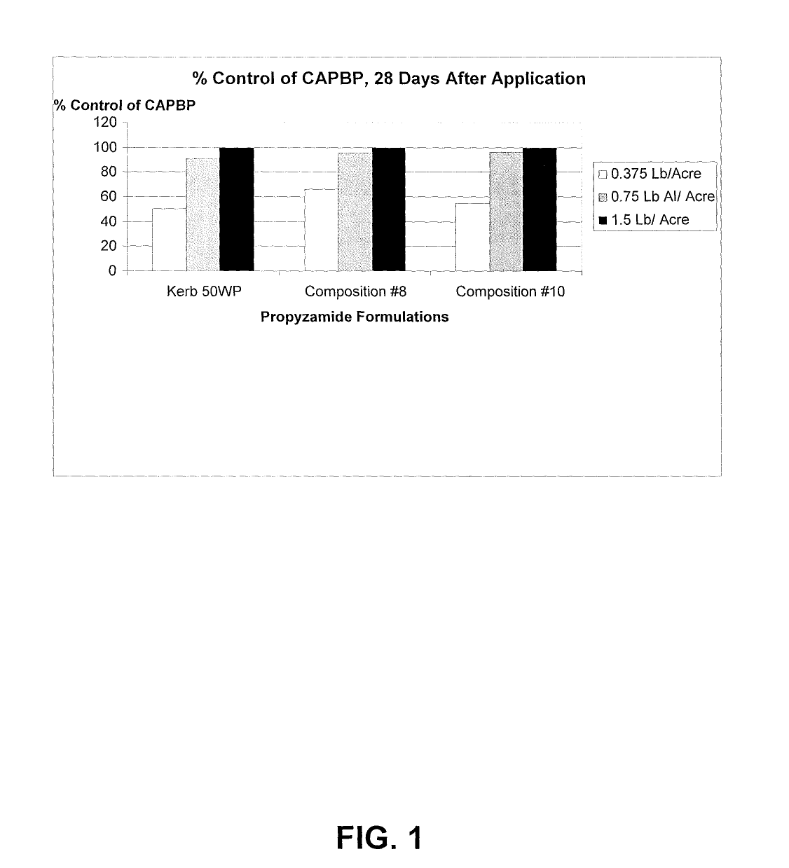

### DETAILED DESCRIPTION

### I. Overview of Several Embodiments

Embodiments of the invention include agricultural compositions that may be used to increase the retention (or decrease the disappearance) of an active chemical in a target area of soil to which the composition is applied. In particular examples, a composition of the invention may be prepared by coating solid particulate (e.g., solid micronized) ingredients with a polymer, for example and without limitation, via a spray-dry process. Thus, methods of making compositions of the invention are also disclosed. Further disclosed are methods of using a composition of the invention, for example, to increase the persistence of an active chemical in a target zone of soil to which the composition is applied.

In particular embodiments, a technical grade active chemical that may be a solid may be micronized. Any solid, soil-applied active chemical, or any solid, foliar-applied active chemical that has soil activity, may be used in certain embodiments of the invention, so long as the active chemical can be micronized, for example and without limitation, to a size of between about 0.1 μm and about 100 μm. Examples of classes of active chemicals that may be used in some embodiments include, without limitation: pesticides; herbicides (e.g., propyzamide); fungicides; insecticides; biocides; etc. In certain embodiments, an active chemical that may not be a solid at a particular temperature (e.g., a liquid and a wax) may be incorporated into a composite composition with a carrier (e.g., a silica carrier), such that the composite composition is a solid.

In some embodiments, a polymer-coated particulate composition comprising a biologically active compound may be formulated as a suspension, a granule product, a powder, or any other formulation type that may facilitate the application of the particulate composition in a commercial formulation.

### II. Terms

Pesticide: As used herein, the term “pesticide” refers to a chemical compound that has a biological activity against an organism. Thus, a pesticide may be any substance, or mixture of substances, capable of preventing, destroying, repelling or mitigating any pest. A pesticide may be a chemical substance, biological agent (such as a virus or bacterium), antimicrobial, disinfectant, or device used against any pest. Pests include, without limitation, insects, plant pathogens, invasive plants (e.g., weeds), molluscs, birds, mammals, fish, nematodes (roundworms), and microbes that destroy property, spread disease, or cause a nuisance.

The biological activity of a pesticide is determined by its active ingredient (which may also be called the active substance). Generally, pesticide products very rarely consist of pure technical material. However, in some embodiments of the invention, a pesticide is provided as a pure technical material. The active ingredient is usually formulated with other materials, and any material, such as a carrier, that may be incorporated in a solid particle comprising the active ingredient, may be so incorporated in some embodiments for polymer coating.

Subclasses of pesticides include, for example and without limitation: herbicides, insecticides, fungicides, rodenticides, pediculocides, biocides, algicides, avicides, bactericides, acaricides, molluscicides, nematicides, rodenticides, and virucides.

Pesticides can be classified by target organism, chemical structure, and physical state. Pesticides can also be classed as inorganic, synthetic, or biologicals (biopesticides), although this distinction may not be clear in every case. Biopesticides include, for example, both microbial pesticides and biochemical pesticides. Plant-derived pesticides (sometimes referred to as “botanicals”) include, for example and without limitation: the pyrethroids; rotenoids; nicotinoids; and a group that includes strychnine and scilliroside.

Many pesticides can also be grouped into chemical families. For example, insecticides include organochlorines, organophosphates, and carbamates. Organochlorine hydrocarbons may be further separated into dichlorodiphenylethanes, cyclodiene compounds, and other related compounds that operate by disrupting the Na⁺/K⁺ balance of insect nerve fibers, forcing the nerve to transmit continuously. Herbicides include phenoxy and benzoic acid herbicides (e.g., 2,4-D), triazines (e.g., atrazine), ureas (e.g., diuron), and chloroacetanilides (e.g., alachlor). Phenoxy compounds tend to selectively kill broadleaved weeds rather than grasses. The phenoxy and benzoic acid herbicides function similar to plant growth hormones, leading to cell growth without normal cell division, and thereby crushing the plant's nutrient transport system. Triazines interfere with photosynthesis.

In view of the foregoing, it will be clear that the term “pesticide,” for the purposes of the present disclosure, encompasses all classes of biologically active chemicals that are useful to control the population of an organism.

Formulation: As used herein, the term “formulation” refers to a mixture that is prepared according to a specific procedure (i.e., the “formula”). Formulation may improve the properties of a pesticide for handling, storage, application, and it may substantially influence its effectiveness and safety. Formulation terminology follows a two-letter convention (e.g., GR denotes “granules”), listed by CropLife International in the Catalogue of Pesticide Formulation Types and International Coding System, Technical Monograph no. 2, 6^{th} Ed. However, some manufacturers do not follow these industry standards, which can cause confusion for users.

Pesticide formulations for mixing with water and application as a spray are common. Water-compatible formulations include: emulsifiable concentrates (EC), wettable powders (WP), soluble liquid concentrates (SL), and soluble powders (SP). Non-powdery formulations with reduced use (or no use) of hazardous solvents that may have improved stability include: suspension concentrates (SC); capsule suspensions (CS); and water dispersible granules (WG). Other pesticide formulations include: granules (GR) and dusts (DP), although for improved safety the latter have generally been replaced by microgranules (MG). Specialist formulations are available for ultra-low volume spraying, fogging, fumigation, etc. Some pesticides (e.g., malathion) may be sold as technical material (TC—which is mostly AI, but also typically contains small quantities of (usually non-active) by-products of the manufacturing process). In embodiments of the present invention, a polymer-coated particulate composition comprising a biologically active compound may be included in any formulation (including those set forth above) that facilitates the application of the compound in an effective manner.

Target zone: As used herein, the term “target zone” (for example, a soil target zone) refers to an area and/or volume. For example, a soil target zone may refer to a two-dimensional surface area of soil to which a formulation is applied, and also to a three-dimensional volume, defined by the two-dimensional area and a specified soil depth. Some embodiments involve a soil target zone to which a formulation or product is to be applied in order to provide a biological effect mediated by the formulation or product. In particular embodiments and examples, a soil target zone may be a weed germination zone that is defined by the surface area to which a formulation is applied, and a soil depth defined by the soil depth at which a weed may germinate (e.g., 4 inches, 6 inches, and 8 inches). It is understood that the soil depth at which a targeted weed species may germinate depends upon the identity of the targeted weed species.

### III. Polymer-Coated Micronized Chemicals

Solid polymer-coated particulate compositions may comprise a biologically active compound (e.g., a pesticide). Any chemical composition that may be formulated in solid particles may be used in some or all embodiments of the invention. For example, a solid biologically active compound may be coated with a polymer to form a composition of the invention. Further, a solid biologically active compound may be incorporated with one or more additional materials in a solid composite composition, wherein the solid composite composition is coated with a polymer. Still further, a biologically active compound that is not a solid may be incorporated with one or more additional materials in a solid composite composition, wherein the solid composite composition is coated with a polymer.

In particular embodiments, a solid polymer-coated particulate composition comprising a biologically active compound may reduce the disappearance of the biologically active compound from soil to which the composition is applied, when compared to uncoated particles. For example, when the polymer-coated composition is applied to a target zone, the biologically active compound may persist longer and/or remain in a greater concentration in the target zone. The biologically active compound also may move at a reduced rate and/or in smaller amounts to areas adjacent and/or near to the target zone (e.g., by leaching).

In some embodiments, a biologically active compound in a polymer-coated particle may be selected from a group of pesticides comprising herbicides, insecticides, nematocides, fungicides, and other chemicals that may require soil incorporation. For example, a chemical in a large-diameter particle may be a pesticide selected from a group comprising the herbicides: cyhalofop-butyl, haloxyfop, penoxsulam, flumetsulam, cloransulam-methyl, florasulam, pyroxsulam, diclosulam, fluoroxypyr, clopyralid, acetochlor, triclopyr, isoxaben, 2,4-D, MCPA, dicamba, MSMA, oxyfluorfen, oryzalin, trifluralin, benfluralin, ethalfluralin, aminopyralid, atrazine, picloram, tebuthiuron, pendimethalin, propanil, propyzamide, glyphosate, and glufosinate.

In further embodiments, a chemical in a biologically active compound may be a pesticide selected from a group comprising the insecticides: organophosphate insecticides (e.g., chlorpyrifos), molt accelerating compounds (e.g., halofenozide, methoxyfenozide and tebufenozide), pyrethroids (e.g., gamma-cyhalothrin and deltamethrin), and biopesticides (e.g., spinosad and spinetoram). A chemical in a biologically active compound may also be a pesticide selected from a group comprising the fungicides: mancozeb, myclobutanil, fenbuconazole, zoxamide, propiconazole, quinoxyfen and thifluzamide.

In particular embodiments, the biologically active compound in a solid polymer-coated particulate composition may be, for example, a solid, a wax, and a liquid. The biologically active compound may be incorporated into a composite composition with other materials prior to polymer coating. In embodiments, the composite composition may be a solid at a temperature of at least about 50° C. (for example and without limitation, 45° C., 46° C., 47° C., 48° C., 49° C., 50° C., 51° C., 52° C., 53° C., 54° C., and 55° C.). In particular embodiments, the composite composition may comprise a wetting agent, a dispersing agent, a carrier, a silica carrier, a lipid-based colloidal carrier, an inert mineral carrier, a dry carrier, a filler, and/or a clay, etc.

In some embodiments, a particle that is coated with a polymer may be greater than about 0.1 μm in diameter. For example, in particular embodiments, a large-diameter particle may be at least about 0.1 μm in diameter (e.g., at least about 0.1, 0.2, 0.3, 0.4, 0.5, 0.6, 0.7, 0.8, 0.9, 1, 2, 3, 4, 5, 6, 7, 8, and 9 μm, etc.) in diameter; at least about 1 μm in diameter; at least about 10 μm in diameter; at least about 20 μm in diameter; at least about 30 μm in diameter; at least about 40 μm in diameter; at least about 50 μm in diameter; at least about 60 μm in diameter; at least about 70 μm in diameter; at least about 80 μm in diameter; at least about 90 μm in diameter; at least about 100 μm in diameter; and at least about 110 μm, or more, in diameter.

In some embodiments, a polymer-coated particulate composition comprising a biologically active compound may be coated with a hydrophobic polymer (e.g., an essentially water-insoluble polymer, a water-insoluble polymer, a polymer that is not readily soluble in water, an oil-based polymer, etc.). For example, in particular embodiments, a polymer-coated particulate composition comprising a biologically active compound may be coated with a latex polymer. In particular examples, the polymer may be, for example and without limitation, a binder and/or encapsulating material, such as those set forth in Table 1.

TABLE 1
Polymer-coating materials

| | | |
|---|---|---|
| UCAR ® 379G | Binder/ | Vinyl-Acrylic Latex |
| | encapsulating | |
| | material | |
| UCAR ® 627 | Binder/ | 100% Acrylic Latex |
| | encapsulating | |
| | material | |
| UCAR ® 418 | Binder/ | Cationic Latex |
| | encapsulating | |
| | material | |
| NEOCAR ® 820 | Binder/ | Acrylic Latex |
| | encapsulating | |
| | material | |
| NEOCAR ® 2300 | Binder/ | Vinyl-Acrylic Latex |
| | encapsulating | |
| | material | |
| AGRIMER ® VA 3E | Binder/ | Polyvinylpyrrolidone/ |
| | encapsulating | Polyvinylacetate Co-polymer |
| | material | |
| AGRIMER ® VA 6 | Binder/ | Polyvinylpyrrolidone/ |
| | encapsulating | Polyvinylacetate Co-polymer |
| | material | |
| AGRIMER ® 30 | Binder/ | Polyvinylpyrrolidone |
| | encapsulating | |
| | material | |
| CELVOL ® 205 | Binder/ | Polyvinylacetate with 88% |
| | encapsulating | Hydrolysis |
| | material | |
| Methocel ™ K4M | Binder/ | Hydroxypropyl Methylcellulose |
| | encapsulating | |
| | material | |
| Chitosan | Binder/ | Chitosan |
| | encapsulating | |
| | material | |
| Sodium Alginate | Binder/ | Sodium Alginate |
| | encapsulating | |
| | material | |
| LyckebyCulinar AB | Binder/ | Water-soluble Starch |
| Starch | encapsulating | |
| | material | |

In certain embodiments, a polymer-coated particulate composition may be produced by a method comprising providing a solid particulate composition (e.g., a solid biologically active compound, and a composite composition comprising a biologically active compound), and adhering a polymer to the surface of a solid particle of the composition. In some embodiments, the polymer may be adhered to the surface of the solid particle by a spray-dry process. For example, water may be added first to an appropriately sized container, followed by any wetting and/or dispersing agents, and then a biologically active compound may be added to the mixture. The mixture may be processed (e.g., for dispersion, and to improve consistency). The mixture may be milled until a desired particle size (or sizes) is obtained, for example, in a suspension concentrate.

In particular embodiments, a spray-dried formulation may be prepared by a method comprising providing a solid particulate composition (e.g., a solid biologically active compound, and a composite composition comprising a biologically active compound) in a container of suitable volume, and optionally adding any wetting agents, dispersing agents, binders, and encapsulating materials, with an appropriate amount of water to make a slurry or suspension. The resultant slurry or suspension may be spray-dried (e.g., with a Büchi B-290 Mini Spray Dryer outfitted with a Orion SAGE model 365 syringe pump to deliver the slurry or suspension into the spray dryer at a controlled rate).

A formulation comprising a polymer-coated particulate composition may include other compounds. For example, in some embodiments, a pesticidal composition may include between about 1 weight percent and about 20 weight percent (e.g., from about 1 weight percent to about 7 weight percent) of at least one surfactant. A surfactant may be anionic, cationic, or nonionic in character. Typical surfactants include, without limitation: salts of alkyl sulfates (e.g., diethanolammonium lauryl sulfate), alkylarylsulfonate salts (e.g., calcium dodecylbenzenesulfonate), alkyl and/or arylalkylphenol-alkylene oxide addition products (e.g., nonylphenol-C18 ethoxylate), alcohol-alkylene oxide addition products (e.g., tridecyl alcohol-C16 ethoxylate), soaps (e.g., sodium stearate), alkylnaphthalenesulfonate salts (e.g., sodium dibutylnaphthalenesulfonate), dialkyl esters of sulfosuccinate salts (e.g., sodium di(2-ethylhexyl) sulfosuccinate), sorbitol esters (e.g., sorbitol oleate), quaternary amines (e.g., lauryl trimethylammonium chloride), ethoxylated amines (e.g., tallowamine ethoxylated), betaine surfactants (e.g., cocoamidopropyl betaine), polyethylene glycol esters of fatty acids (e.g., polyethylene glycol stearate), block copolymers of ethylene oxide and propylene oxide, salts of mono and dialkyl phosphate esters, and mixtures thereof.

In particular embodiments, a surfactant may be selected from a group comprising polymers, sulfates of alkoxylated alkanoles, fatty alcohol polyglycol ethers, and polysorbates. By way of example and not limitation, the surfactant may be a C12 alcohol ethoxylate, such as an ethoxylated lauryl alcohol surfactant. An example of such an ethoxylated lauryl alcohol surfactant is AGNIQUE® DMF 112S, which is commercially available from Cognis Corporation (Cincinnati, Ohio). A polymeric surfactant, such as that commercially available from Huntsman International LLC (The Woodlands, Tex.) under the trademark TERSPERSE® 2500 series, may also be employed. An alcohol polyglycol ether, such as ETHYLAN™ NS 500 LQ alcohol polyglycol ether (Akzo Nobel; Chicago, Ill.), may also be employed. For example, the pesticidal composition may include between about 0.05 weight percent and about 2 weight percent (e.g., about 0.3 weight percent) of the AGNIQUE® DMF 1125, between about 0.5 weight percent and about 4 weight percent of the TERSPERSE® 2500 series, and, e.g., about 1.9 weight percent and the ETHYLAN™ NS 500 LQ.

A pesticidal composition may also optionally include a thickener. For example, in some embodiments, a pesticidal composition may include between about 0.05 weight percent and about 0.5 weight percent of a thickener. One example of a thickener is an organic gum (e.g., xanthan gum, such as KELZAN® S xanthan gum). For example, in particular embodiments, a pesticidal composition may include about 0.2 weight percent of KELZAN® S xanthan gum.

A pesticidal composition may also optionally include a dispersant. For example, in some embodiments, a pesticidal composition may include between about 0.5 weight percent and about 6 weight percent of a dispersant. One example of a dispersant is MORWET® D-425 powder (Akzo Nobel), which includes a blend of an alkyl naphthalene sulfonate condensate and lignosulfonate. For example, in particular embodiments, a pesticidal composition may include about 2.9 weight percent of MORWET® D-425 powder.

A pesticidal composition may also optionally include a preservative. For example, in some embodiments, a pesticidal composition may include between about 0.5 weight percent and about 6 weight percent of a preservative. One example of a preservative is PROXEL® GXL preservative (Arch UK Biocides Limited; England). For example, in particular embodiments, a pesticidal composition may include about 0.1 weight percent of PROXEL® GXL preservative.

A pesticidal composition may also optionally include a rheology stabilizer. For example, in some embodiments, a pesticidal composition may include between about 0.5 weight percent and about 6 weight percent of a rheology stabilizer. One example of a rheology stabilizer is a microcrystalline cellulose gel (e.g., AVICEL® CL 611 rheology stabilizer; FMC Corporation (Philadelphia, Pa.)). For example, in particular embodiments, a pesticidal composition may include about 1.1 weight percent of the AVICEL® CL 611 rheology stabilizer.

A pesticidal composition may also optionally include between about 0.05 weight percent and about 1 weight percent of a buffer. The buffer may include, for example, and aqueous solution of a weak acid and its conjugate base of a weak base and its conjugate acid. The buffer solution may be formulated to maintain a desired pH of the insecticide formulation.

In particular embodiments, a pesticidal composition may also include between about 2 weight percent and about 10 weight percent and, more particularly, between about 3 weight percent and about 6 weight percent of the propylene glycol.

In some embodiments, a base formulation may be combined with a liquid carrier and a self-emulsifiable ester. Examples of suitable liquid carriers include, but are not limited to: liquid carriers including benzene, alcohols, acetone, xylene, methylnaphthalene, dioxane and cyclohexanone. Examples of self-emulsifiable esters include, but are not limited to, succinate triglyceride oil derived from maleating triglyceride oil (e.g., VEG-ESTER® additives; Lubrizol, Inc.). For example, a pesticidal composition may be formed by combining between about 10 weight percent and about 30 weight percent of the base formulation with between about 30 weight percent and about 50 weight percent of each of cyclohexanone and VEG-ESTER® GY-350 additive. Further examples of the use of self-emulsifiable carriers in pesticide application are provided in U.S. Patent Application 2010/0113275.

A formulation comprising a polymer-coated particulate composition comprising a biologically active compound may also optionally comprise one or more fillers in some embodiments. Fillers which may be incorporated into a large-diameter chemical particle may include, for example, powdered or granular materials, including without limitation: diatomites, attapulgites, bentonites, talcs, montmorillonites, perlites, vermiculites, calcium carbonates, corncob grits, wood flour, lignin sulfonates, etc.

In addition to the formulations set forth above, a polymer-coated particulate composition comprising a biologically active compound may also be included in a formulation in combination with one or more additional compatible ingredients. Other additional ingredients may include, for example and without limitation: one or more other biologically active compound(s); dyes; and any other additional ingredients providing functional utility (e.g., fragrances, viscosity-lowering additives, and freeze-point depressants).

Kits and suspensions comprising a polymer-coated particulate composition comprising a biologically active compound are also provided in some embodiments. In particular examples, a kit may comprise polymer-coated particles comprising a biologically active compound, and may further comprise other ingredients and/or materials to be incorporated in a formulation with the coated particles.

While it is possible to utilize the compounds directly as herbicides, it is preferable to use them in mixtures containing a herbicidally effective amount of the compound along with at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with the compounds of Formula I or other composition ingredients. Such mixtures can be designed for application directly to weeds or their locus or can be concentrates or formulations that are normally diluted with additional carriers and adjuvants before application. They can be solids, such as, for example, dusts, granules, water dispersible granules, or wettable powders, or liquids, such as, for example, emulsifiable concentrates, solutions, emulsions or suspensions. They can also be provided as a pre-mix or tank mixed.

Suitable agricultural adjuvants and carriers that are useful in preparing the herbicidal mixtures of the invention are well known to those skilled in the art. Some of these adjuvants include, but are not limited to, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Liquid carriers that can be employed include water and organic solvents. The organic solvents typically used include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is generally the carrier of choice for the dilution of concentrates.

Suitable solid carriers include talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, and the like.

It is usually desirable to incorporate one or more surface-active agents into the compositions of the present invention. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in “McCutcheon's Detergents and Emulsifiers Annual,” MC Publishing Corp., Ridgewood, N.J., 1998 and in “Encyclopedia of Surfactants,” Vol. I-III, Chemical publishing Co., New York, 1980-81. Typical surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, particularly methyl esters.

Oftentimes, some of these materials, such as vegetable or seed oils and their esters, can be used interchangeably as an agricultural adjuvant, as a liquid carrier or as a surface active agent.

Other adjuvants commonly used in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

The compositions of the present invention may be applied in conjunction with one or more other non-polymer coated pesticide to control a wider variety of undesirable pests. When used in conjunction with these other non-polymer coated pesticides, the presently claimed compositions can be formulated with the other non-polymer coated pesticide or pesticides as premix liquid or solid concentrates, tank mixed with the other non-polymer coated pesticide or pesticides for spray application or applied sequentially with the other non-polymer coated pesticide or pesticides in separate spray applications. The non-polymer coated pesticide or pesticides may include one or more of an insecticide, an herbicide, a fungicide, an acaricide, a nematicide, a biocide, etc.

Suitable non-polymer coated herbicides for use in conjunction with the compositions of the present invention may be selected from, but are not limited to: 4-CPA; 4-CPB; 4-CPP; 2,4-D; 3,4-DA; 2,4-DB; 3,4-DB; 2,4-DEB; 2,4-DEP; 3,4-DP; 2,3,6-TBA; 2,4,5-T; 2,4,5-TB; acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofluor, benzoylprop, benzthiazuron, bicyclopyrone, bifenox, bilanafos, bispyribac, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chlorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P, fenoxasulfone, fenteracol, fenthiaprop, fentrazamide, fenuron, ferrous sulfate, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, fluoroxypyr, flurtamone, fluthiacet, fomesafen, foramsulfuron, fosamine, furyloxyfen, glufosinate, glufosinate-P, glyphosate, halosafen, halosulfuron, haloxydine, haloxyfop, haloxyfop-P, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, parafluoron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, thidiazimin, thidiazuron, thiencarbazone-methyl, thifensulfuron, thiobencarb, tiocarbazil, tioclorim, topramezone, tralkoxydim, triafamone, tri-allate, triasulfuron, triaziflam, tribenuron, tricamba, triclopyr, tridiphane, trietazine, trifloxysulfuron, trifluralin, triflusulfuron, trifop, trifopsime, trihydroxytriazine, trimeturon, tripropindan, tritac, tritosulfuron, vernolate and xylachlor.

### IV. Movement of Soil-Incorporated Polymer-Coated Chemicals

Also provided are methods that take advantage of the finding that the disappearance of an active compound (e.g., a pesticide, and a herbicide) from a zone of soil can be reduced (or its retention and/or persistence increased) by applying the active compound in a polymer-coated particulate composition. Some embodiments include methods for decreasing the rate at which an active compound is leached from a target zone. These and further embodiments also include methods for increasing the persistence of an active compound in a target zone. In particular examples, a polymer-coated particulate composition comprising a biologically active compound may be suspended in water and applied to a target zone. In particular examples, a target zone is an area of soil with a horizontal and a vertical dimension. A target zone may have any size.

Soil consists of three different phases: a solid phase that contains mainly minerals of varying sizes and organic compounds that accounts for approximately 20% of the soil space, and liquid and gas phases that are contained within the total pore space. The total pore space accounts for the remaining approximately 80% of the soil space. There are three main categories of soil pores (i.e., macropores, mesopores, and micropores) that all have different characteristics and contribute different attributes to soils, depending on the number and frequency of each type of pore that occurs in a particular soil.

Soils are classified according to the proportion of mineral particles of different sizes present. The porosity of surface soil typically decreases as the particle size of the soil increases, because of soil aggregate formation in fine-textured surface soils subjected to soil biological processes. Aggregation typically involves particulate adhesion and higher resistance to compaction. For the typical bulk density of sandy soil (approximately between 1.5 and 1.7 g/cm³), the porosity is calculated to be expected to be between 0.43 and 0.36. Typical bulk density of clay soil is between 1.1 and 1.3 g/cm³, which implies a porosity between 0.58 and 0.51. The porosity of subsurface soil is lower than the porosity of surface soil due to compaction by gravity. See, e.g., Brady and Weil, The Nature and Properties of Soils, 12^{th} ed., Upper Saddle River, N.J., Prentice-Hall, 1999.

With a few exceptions, the smaller the particles a soil is composed of, the longer active compounds (e.g., pesticides) persist in it. This may be contrary to what would be expected, since smaller soil particles imply increased porosity (see above). Soil structure affects the leaching of active compounds (which decreases the persistence of the compounds) because the pore size and pore size distribution greatly affect the movement of water through soil. The way in which particle size and structure influences persistence in soil is complex, because structure is also intimately linked with such features as hydrogen ion concentration, organic matter and clay content. For example, an active compound (e.g., a pesticide) may become absorbed on to soil particles, thereby increasing the persistence of the compound. Mechanisms that may be responsible for absorption in certain compound-soil combinations include: physical adsorption; chemical adsorption (i.e., ion exchange or protonation); hydrogen bonding; and coordination (metal complexes). In any one soil, several mechanisms or combinations of mechanisms may exist with regard to a particular compound. Bailey and White (1970) Res. Rev. 32:29.

In general, factors that may influence the amount of adsorption of active compounds by soil colloids include: the physicochemical configuration of the soil particles; the physicochemical configuration of the compound; the dissociation constant of the compound; the water-solubility of the compound; the molecular size of the compound; the soil acidity; temperature; the electrical potential of the soil clay surface; the moisture content of the soil; and the compound formulation. Clay and organic matter are two particular soil constituents that may influence the persistence of pesticides in soils.

Clay particles are the smallest particles in soil (about 2 μm), and soils with more than 40% of clay particles are referred to as clay soils. Such soils have a much larger internal reactive surface area than other soils, thus providing a greater surface area for adsorption of pesticides. There is a strong correlation between the amount of clay in a soil and the ability of the soil to bind and retain pesticides.

The amount of organic matter in particular soils may be, for example, from less than about 1% to more than about 50%. Soil organic matter contributes to the adsorption of pesticides, and there is a correlation between the persistence of pesticides in soils and the amount of organic matter in them. Most of soil organic matter consists of humic compounds that have not been completely characterized, but do have a very high cation exchange capacity. Humic compounds may have functional groups, for example, carboxyl, amino, and phenolic hydroxyl, which may provide sites for hydrogen bonding with certain pesticide molecules.

In view of the complexity of the aforementioned processes and systems, it is an unanticipated result that a polymer-coated particulate composition persists longer in a target zone than an uncoated particulate composition of the same type.

In some embodiments, a polymer-coated particulate composition comprising a biologically active compound may be applied to a target zone by any method known to those of skill in the art. For example, in particular embodiments, a polymer-coated particulate composition may be applied by broadcast spraying, pre-emergent spray application, post-emergent spray application, controlled droplet application, granule application, dust application, aerial spraying, ultra-low volume spray application, crop dusting, or seed treatment. In some embodiments, the polymer-coated particulate composition may be applied to a target zone in a liquid suspension. In other embodiments, the polymer-coated particulate composition may be applied in dry form. Compositions applied in dry form may later be suspended in water, for example, by rain water or irrigation.

One of the more common forms of chemical application, especially in conventional agriculture, is spray application, such as, for example, application using mechanical sprayers. Hydraulic sprayers that may be used to accomplish spray application may consist of a tank, a pump, a lance (for single nozzles) or boom, and a nozzle (or multiple nozzles). Sprayers may convert a chemical formulation (e.g., a suspension of polymer-coated particles comprising an active compound), often containing a mixture of a liquid carrier (e.g., water and fertilizer) and chemical, into droplets. This conversion is accomplished by forcing the spray mixture through a spray nozzle under pressure. The size of droplets produced during spraying may be altered through the use of different nozzle sizes, by altering the pressure under which it is forced, or a combination of the foregoing. Large droplets may have an advantage of being less susceptible to “spray drift,” but generally require more water per unit of target area. Due to static electricity, small droplets may be able to maximize contact with a target organism in the target area, but small droplets are susceptible to spray drift (e.g., during application during periods of high wind).

Air-assisted or mist sprayers may be used for post-emergent pesticide application to tall crops, such as tree fruit, where boom sprayers and aerial application would be ineffective. Air-assisted sprayers inject a small amount of liquid into a fast-moving stream of air, which break down large droplets into smaller droplets. Foggers use a different method to fulfill a similar role to air-assisted sprayers in producing particles of very small size. Whereas air-assisted sprayers create a high-speed stream of air which can travel significant distances, foggers use a piston or bellows to create a stagnant area of pesticide that is often used for enclosed areas, such as houses and animal shelters.

Seed treatment represents a further category of application methods that may achieve high effective dose-transfer efficiency in some embodiments. Seed treatment generally comprises the application of an active compound to a seed prior to planting, in the form of a seed treatment, or coating, to protect against soil-borne risks to the plant. Compositions for seed treatment may additionally provide supplemental chemicals and nutrients that encourage plant growth. A seed coating may include a nutrient layer (containing, e.g., nitrogen, phosphorus, and potassium), a rhizobial layer (containing, e.g., symbiotic bacteria and other beneficial microorganisms), and a pesticide layer to make the seed less vulnerable to pests.

The following examples are provided to illustrate certain particular features and/or embodiments. The examples should not be construed to limit the disclosure to the particular features or embodiments exemplified.

### EXAMPLES

### Example 1

### Polymer-Coated Particulate Composition

A suspension concentrate (SC) of polymer-coated particles of the pesticide, propyzamide, was prepared according to the composition shown in Table 2. The water was added first to an appropriately sized container, followed by the wetting and dispersing agents, and lastly the propyzamide technical material. The mixture was stirred at 2000 rpm with a five-inch dispersing blade for 20 minutes using an overhead mixer. The SC was then homogenized using a Silverson® L4RT-A with a two-inch homogenizer probe for 30 minutes to improve consistency. The homogenized mixture was then transferred to a 250 mL capacity media mill (Eiger Machines Mini Motor Mill 250, Eiger Machines Inc.), where it was milled with 1.0 mm zirconium oxide beads at 5000 rpm until the particle size was reduced to 2.0-4.0 μm D_{(0.5)}. This SC (or another SC of similar composition) was used to prepare all of the listed spray-dried wettable powder (WP) formulations.

Each spray-dried formulation was prepared by adding the milled propyzamide SC to a container of suitable volume, and adding in the wetting agents, dispersing agents, binders, and an appropriate amount of DI water to make the suspension 25% solid content by weight. The resultant slurry was mixed with an IKA® EuroStar power control-visc 6000 with a two-inch dispersing blade. After stirring for 10 minutes at 500 rpm, the formulation was homogenized with a Silverson® L4RT-A for 10 minutes at 5000 rpm. Once homogenized, the formulation was spray-dried with a Büchi™ B-290 Mini Spray Dryer outfitted with an Orion SAGE model 365 syringe pump to deliver the slurry into the spray dyer at a controlled rate of 200-400 mL/hour. The inlet temperature was in the range of 135° C. to 165° C., and the outlet temperature was in the range of 80° C. to 99° C. The aspirator was set to 100%. After all of the slurry was run through the spray dryer, the spray dryer was allowed to cool to ambient temperature, and then the sample was collected typically in a powder form in the collector container below a cyclone chamber. The sample powder was then assayed for propyzamide concentration, and stored in glass jars for further evaluation.

TABLE 2
Propyzamide Suspension Concentrate

| Order of addition | Materials | Percent composition |
|---|---|---|
| 1 | DI H₂O | 60.48% |
| 2 | Borresperse Na | 2.76% |
| 3 | MORWET ® D-425 | 0.79% |
| 4 | GEROPON ® SDS | 0.39% |
| 5 | propyzamide technical | 35.58% |
| | (95% AI) | |

The compositions of polymer-coated propyzamide formulations were provided in Tables 3-10. A description of the co-formulant materials is provided in Table 11.

TABLE 3
Compositions containing UCAR ® 379G Latex

| Material | #1 | #2 | #3 | #4 | #5 | #6 |
|---|---|---|---|---|---|---|
| Propyzamide AI | 81.39% | 73.57% | 69.09% | 46.62% | 46.62% | 64.92% |
| Impurities from technical grade | 4.27 | 3.86 | 3.63 | 2.45 | 2.45 | 3.41 |
| Propyzamide | | | | | | |
| GEROPON ® SDS | 1.19 | 1.08 | 1.01 | 0.68 | 2.68 | 0.95 |
| REAX ® 88A | 4.26 | 3.85 | 3.61 | 2.44 | 2.44 | 3.39 |
| Borresperse Na | 1.96 | — | — | — | — | — |
| MORWET ® D-425 | 1.96 | 7.10 | 10.36 | 9.99 | 9.99 | 9.73 |
| UCAR ® 379G | 4.97 | 10.54 | 12.31 | 11.86 | 11.86 | 11.56 |
| GEROPON ® T-77 | — | — | — | 2.00 | — | — |
| Fe₂O₃ | — | — | — | 23.97 | — | — |
| PERGOPAK ® M | — | — | — | — | 23.97 | — |
| PLURONIC ® p-105 | — | — | — | — | — | 2.14 |
| Methocell ™ K4M | — | — | — | — | — | 3.89 |

TABLE 4
Compositions containing UCAR ® 627

| Material | #7 | #8 | #9 | #10 | #11 | #12 | #13 |
|---|---|---|---|---|---|---|---|
| Propyzamide AI | 73.31% | 70.36% | 64.14% | 77.74% | 81.09% | 79.38% | 81.89% |
| Impurities from tech. grade | 3.86 | 1.61 | 5.50 | 4.09 | 4.26 | 4.17 | 4.31 |
| Propyzamide | | | | | | | |
| GEROPON ® SDS | 0.85 | 0.81 | 0.74 | 0.90 | 0.94 | 0.92 | 0.95 |
| Borresperse Na | 9.09 | 8.91 | 8.12 | 9.45 | 9.86 | 9.65 | 9.96 |
| MORWET ® D-425 | 2.54 | 2.49 | 2.27 | 2.65 | 2.76 | 2.70 | 2.79 |
| UCAR ® 627 | 10.35 | 15.82 | 19.23 | 5.18 | 1.09 | 3.17 | 0.11 |

TABLE 5
Compositions containing NEOCAR ® 820

| Material | #14 | #15 | #16 | #17 |
|---|---|---|---|---|
| Propyzamide AI | 77.91% | 81.09% | 81.88% | 79.38% |
| Impurities from technical | 4.10 | 4.26 | 4.31 | 4.17 |
| grade Propyzamide | | | | |
| GEROPON ® SDS | 0.90 | 0.94 | 0.95 | 0.92 |
| Borresperse Na | 9.40 | 9.86 | 9.96 | 9.65 |
| MORWET ® D-425 | 2.63 | 2.76 | 2.79 | 2.70 |
| NEOCAR ® 820 | 5.06 | 1.08 | 0.12 | 3.17 |

TABLE 6
Compositions containing NEOCAR ® 2300

| Material | #18 | #19 | #20 | #21 |
|---|---|---|---|---|
| Propyzamide AI | 77.74% | 81.09% | 79.38% | 81.89% |
| Impurities from technical grade | 4.09 | 4.26 | 4.17 | 4.31 |
| Propyzamide | | | | |
| GEROPON ® SDS | 0.90 | 0.94 | 0.92 | 0.95 |
| Borresperse Na | 9.45 | 9.86 | 9.65 | 9.96 |
| MORWET ® D-425 | 2.65 | 2.76 | 2.70 | 2.79 |
| NEOCAR ® 2300 | 5.18 | 1.08 | 3.17 | 0.11 |

TABLE 7
Composition containing UCAR ® 418

| Material | #22 |
|---|---|
| Propyzamide AI | 81.89% |
| Impurities from technical grade Propyzamide | 4.31 |
| GEROPON ® SDS | 0.95 |
| Borresperse Na | 9.96 |
| MORWET ® D-425 | 2.79 |
| UCAR ® 418 | 0.11 |

TABLE 8
Compositions containing PVP/PVA polymers and co-polymers

| Material | #23 | #24 | #25 |
|---|---|---|---|
| Propyzamide AI | 77.74% | 77.74% | 77.74% |
| Impurities from technical grade Propyzamide | 4.09 | 4.09 | 4.09 |
| GEROPON ® SDS | 0.90 | 0.90 | 0.90 |
| Borresperse Na | 9.45 | 9.45 | 9.45 |
| MORWET ® D-425 | 2.65 | 2.65 | 2.65 |
| AGRIMER ® VA 3E | 5.18 | — | — |
| AGRIMER ® VA 6 | — | 5.18 | — |
| AGRIMER ® 30 | — | — | 5.18 |

TABLE 9
Composition containing PVOH polymers

| Material | #26 |
|---|---|
| Propyzamide AI | 77.74% |
| Impurities from technical grade Propyzamide | 4.09 |
| GEROPON ® SDS | 0.90 |
| Borresperse Na | 9.45 |
| MORWET ® D-425 | 2.65 |
| CELVOL ® 205 | 5.18 |

TABLE 10
Compositions containing starch, biopolymers, or derivatives

| Material | #27 | #28 | #29 | #30 |
|---|---|---|---|---|
| Propyzamide AI | 77.74% | 79.80% | 77.74% | 77.74% |
| Impurities from technical grade | 4.09 | 4.20 | 4.09 | 4.09 |
| Propyzamide | | | | |
| GEROPON ® SDS | 0.90 | 0.92 | 0.90 | 0.90 |
| Borresperse Na | 9.45 | 9.71 | 9.45 | 9.45 |
| MORWET ® D-425 | 2.65 | 2.72 | 2.65 | 2.65 |
| Methocel ™ K4M | 5.18 | — | — | — |
| Chitosan | — | 2.66 | — | — |
| Sodium Alginate | — | — | 5.18 | — |
| Lyckeby Culinar AB Starch | — | — | — | 5.18 |

TABLE 11
Description of co-formulant materials used in formulations

| Material | Properties | Description | Purchased from |
|---|---|---|---|
| GEROPON ® SDS | Wetting agent | Dioctyl Sodium Sulfosuccinate | Rhodia |
| REAX ® 88A | Dispersing agent | Lignosulfonate | MeadWestvaco |
| Borresperse Na | Dispersing agent | Lignosulfonate | Borregaard |
| | | | Lignotech |
| MORWET ® D-425 | Wetting agent | Naphthalene sulfonate | Akzo-Nobel |
| GEROPON ® T-77 | Wetting agent | 2-[methyl[(9Z)-1-oxo-9-octadecen-1-yl]amino]- | Rhodia |
| | | ethanesulfonic acid, Na salt | |
| PLURONIC ® P-105 | Wetting agent | Block Co-polymer of Polyethylene Oxide and | BASF |
| | | Polypropylene Oxide | |
| Fe₂O₃ | Carrier/filler | Iron (III) Oxide | Magnetics |
| | | | International, Inc. |
| PERGOPAK ® M | Carrier/filler | Polyurea | Albamarle |
| UCAR ® 379G | Binder/encapsulating | Vinyl-Acrylic Latex | Dow Chemical |
| | material | | |
| UCAR ® 627 | Binder/encapsulating | 100% Acrylic Latex | Dow Chemical |
| | material | | |
| UCAR ® 418 | Binder/encapsulating | Cationic Latex | Dow Chemical |
| | material | | |
| NEOCAR ® 820 | Binder/encapsulating | Acrylic Latex | Dow Chemical |
| | material | | |
| NEOCAR ® 2300 | Binder/encapsulating | Vinyl-Acrylic Latex | Dow Chemical |
| | material | | |
| AGRIMER ® VA 3E | Binder/encapsulating | Polyvinylpyrrolidone/Polyvinylacetate | ISP International |
| | material | Co-polymer | |
| AGRIMER ® VA 6 | Binder/encapsulating | Polyvinylpyrrolidone/Polyvinylacetate | ISP International |
| | material | Co-polymer | |
| AGRIMER ® 30 | Binder/encapsulating | Polyvinylpyrrolidone | ISP International |
| | material | | |
| CELVOL ® 205 | Binder/encapsulating | Polyvinylacetate with 88% Hydrolysis | Celanese |
| | material | | |
| Methocel ™ K4M | Binder/encapsulating | Hydroxypropyl Methylcellulose | Dow Chemical |
| | material | | |
| Chitosan | Binder/encapsulating | Chitosan | Sigma Aldrich |
| | material | | |
| Sodium Alginate | Binder/encapsulating | Sodium Alginate | Sigma Aldrich |
| | material | | |
| Lyckeby Culinar AB | Binder/encapsulating | Water-soluble Starch | Lcykeby Culinar |
| Starch | material | | |

### Example 2

### Increased Retention of Active Ingredients in a Soil Zone

Polymer-coated particulate compositions comprising propyzamide as an active ingredient showed improved retention and residue of propyzamide in the soil zone to which the polymer-coated particles were applied; i.e., the top layer of soil, which is the most effective biological control zone. The compositions for the three formulations that were used in these experiments, composition #8 and composition #10, and Kerb™ 50W are listed in Table 12.

TABLE 12
Compositions used in field trials

| | | Composition | Composition |
|---|---|---|---|
| Materials | Kerb ™ 50W | #8 | #10 |
| Propyzamide | 50.5% | 69.44% | 77.99% |
| Calcium Lignosulfonate | 5% | — | — |
| Tamol 731 SD | 1% | — | — |
| Triton X-120 AG | 0.5% | — | — |
| Kaolin P300 Clay | 43% | — | — |
| | | — | — |
| Borresperse Na | — | 8.68% | 9.38% |
| MORWET ® D-425 | — | 2.43% | 2.63% |
| UCAR ® 627 | — | 15.00% | 5.00% |
| GEROPON ® SDS | — | 0.80% | 0.90% |
| Impurities from Technical | — | 3.65% | 4.10% |
| Material | | | |

Table 13 shows the average concentration of propyzamide in micrograms per gram of soil in the top 1 inch of soil. These data represent the average of several soil cores taken from a field trial that were analyzed at the specified depths for propyzamide concentration. These data show that the coated formulations, composition #10 and composition #8 provided a significantly higher concentration of propyzamide in the top 1 inch of soil compared to the uncoated, commercially available propyzamide particle product Kerb™ 50W.

### Field Trial Protocol

Field trials were conducted in California under bare ground conditions using standard herbicide small plot research methodology. Plot size was 7×20 feet. Prior to applying the treatments, trial area preparation was completed using normal agricultural procedures to destroy existing vegetation and prepare the soil for the herbicide applications. All treatments were applied pre-emergence to weed germination. The trial site was irrigated to activate the treatments and to move the propyzamide active ingredient into the soil. There were four replicates per treatment.

All treatments in the field trial were applied by calculating the active ingredient rate applied on an area basis and then mixing each treatment separately in water and applying at a spray volume of 20 gallons per acre (187 L/ha). Treatments were applied with a CO₂ backpack sprayer using turbojet spray nozzles at a spray pressure of 30 psi. Treatments were rated as compared to the untreated control plots.

The treated plots and control plots were rated blind at various intervals after application. Ratings were based of percent (%) visual weed control, where 0% corresponds to no control and 100% corresponds to complete kill. After rating was completed, plots were sampled with a mechanical tractor powered soil sampler using standard soil sampling procedures and methodologies using plastic tube inserted into soil sampling probe. Each soil sample was taken to a depth of 18 inches. Immediately upon sampling, soil cores were placed in a freezer and maintained frozen until processed.

TABLE 13
Herbicidal Efficacy of Formulations
Herbicidal Efficacy of Probe Kerb Formulations when soil applied PRE for weed control in CA
in 2010.

| Eval Date | | | | | 1/6/2011 | 1/6/2011 | 1/6/2011 |
|---|---|---|---|---|---|---|---|
| Pest Bayer Code* | | | | | CAPBP | POAAN | STEME |
| Evaluation | | | | | % VISUAL | % VISUAL | % VISUAL |
| | | | | | CONTROL | CONTROL | CONTROL |
| Trt-Eval Interval* | | | | | 76 DAYS | 76 DAYS | 76 DAYS |
| Trt | Treatment | | Rate | Appl | | | |
| Num | Name | Rate | Unit | Method | | | |
| 1 | KERB 50WP | 0.188 | lb ai/a | PRE | 8 d | 50 a | 23 b |
| 2 | KERB 50WP | 0.375 | lb ai/a | PRE | 38 c | 75 a | 75 ab |
| 3 | KERB 50WP | 0.75 | lb ai/a | PRE | 89 a | 100 a | 100 a |
| 4 | Composition #8 | 0.188 | lb ai/a | PRE | 20 d | 100 a | 73 ab |
| 5 | Composition #8 | 0.375 | lb ai/a | PRE | 68 b | 100 a | 98 a |
| 6 | Composition #8 | 0.75 | lb ai/a | PRE | 96 a | 76 a | 99 a |
| 7 | Composition #10 | 0.188 | lb ai/a | PRE | 13 d | 73 a | 75 ab |
| 8 | Composition #10 | 0.375 | lb ai/a | PRE | 73 b | 98 a | 90 a |
| 9 | Composition #10 | 0.75 | lb ai/a | PRE | 95 a | 100 a | 100 a |

| | | | |
|---|---|---|---|
| LSD (P = .05) | 12.7 | 49.1 | 45.2 |
| Standard Deviation | 8.7 | 33.6 | 31 |
| CV | 15.8 | 39.29 | 38.14 |
| Bartlett's X2 | 21.585 | 28.309 | 25.832 |
| P(Bartlett's X2) | 0.006* | 0.001* | 0.001* |

Means followed by same letter do not significantly differ (P = .05, Student-Newman-Keuls)
Summary includes 9 of 13 treatments.
CAPBP = Shepherds purse, Capsella bursa-pastoris
POANN = Annual bluegrass, Poa annua
STEME = Chickweed, Stellaria media

Table 13 shows data demonstrating the average control (%) of CAPBP (Capsella bura-pastoris (Shepherd's purse)) 76 days after application of several polymer-coated propyzamide formulations (Compositions #8 and #10, respectively, and a control non-coated propyzamide formulation (Kerb 50WP). Data were collected for three application rates of each formulation as measured for control of Shepherds purse (Capsella bursa-pastoris), Annual bluegrass (Poa annua), and Chickweed (Stellaria media).

Analytical Method for the Determination of Propyzamide from Soil Cores

### Preparation of Standard Solutions:

A standard stock solution was prepared by weighing approximately 25.5 mg of propyzamide analytical standard (TSN105825, purity 98.2%) into a 25 ml volumetric flask and filling to volume with methanol. Concentration was approx. 1000 micrograms/ml. Using the standard stock solution, six working standards were prepared by serial dilutions in methanol yielding concentrations of 0.25, 0.5, 1, 5, 10 and 20 micrograms/ml.

Sample preparation for propyzamide soil cores. To prepare the soil cores for analysis they had to be thawed in advance for 45-60 minutes. During this time, 250 mL jars were weighed. Once the core was thawed it was sectioned off and each section was placed into a 250 mL jar. The jars were then weighed again to determine the actual weight of the soil segment. Once weighed, 200 mL of methanol was added to each jar. The jars were then sonicated for 15 minutes and shaken for 45 minutes at 200 rpm. After the shaking was complete, the jars were allowed to settle for 15 minutes before an aliquot was taken with a plastic syringe. The aliquot was filtered through a 0.45 μm nylon filter into an autosampler vial for HPLC analysis.

Chromatographic Conditions:

Instrument: HPLC Agilent 1100

Column: Phenomenex Luna C18 (150×4.6 mm) 3 um S/N 302448

Mobile phase: Isocratic: 80% Acetonitrile: 20% Acetic Acid in water 0.4% v/v.

Flow rate: 1 ml/min.

Detection: 230 nm.

Temperature: 25 C.

Injection volume: 10 μL.

TABLE 14
Propyzamide retention in the top one inch of soil

| | Average Propyzamide |
|---|---|
| Composition | Concentration (μg/g sample) |
| Kerb 50WP | 5.87 |
| #8 | 10.05 |
| #10 | 9.61 |

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the scope of the invention as defined by the following appended claims and their legal equivalents.

What may be claimed is:

1. A polymer-coated particulate composition comprising a biologically active compound.

2. The polymer-coated particulate composition of claim 1, wherein the biologically active compound is a pesticide.

3. The polymer-coated particulate composition of claim 2, wherein the biologically active compound is propyzamide.

4. The polymer-coated particulate composition of claim 1, comprising particles of the biologically active compound that are between about 0.1 and about 100 microns in diameter.

5. The polymer-coated particulate composition of claim 4, comprising particles of the biologically active compound are between about 1 and about 30 microns in diameter.

6. The polymer-coated particulate composition of claim 4, wherein essentially all of the particles of the biologically active compound are between about 0.1 and about 100 microns in diameter.

7. The polymer-coated particulate composition of claim 4, wherein the particles of the biologically active compound have a median diameter of about 0.5 microns to about 100 microns.

8. The polymer-coated particulate composition of claim 1, wherein the composition comprises particles that consist of the biologically active compound and a polymer coating.

9. The polymer-coated particulate composition of claim 1, wherein the composition comprises particles that comprise the biologically active compound and a polymer coating.

10. The polymer-coated particulate composition of claim 9, wherein the composition comprises particles that comprise the biologically active compound, a polymer coating, and at least one additional material.

11. The polymer-coated particulate composition of claim 1, wherein the biologically active compound is a technical material.

12. The polymer-coated particulate composition of claim 1, wherein the biologically active compound is a solid.

13. The polymer-coated particulate composition of claim 1, wherein the biologically active compound is not a solid.

14. The polymer-coated particulate composition of claim 13, wherein the composition comprises composite particles that comprise the biologically active compound and at least one additional material making the composite particle a solid, and a polymer coating.

15. The polymer-coated particulate composition of claim 9, wherein the polymer is a hydrophobic polymer.

16. The polymer-coated particulate composition of claim 15, wherein the polymer is a latex polymer.

17. The polymer-coated particulate composition of claim 15, wherein the polymer is a polymer that is not readily soluble in water.

18. The polymer-coated particulate composition of claim 17, wherein the polymer is an essentially water-insoluble polymer.

19. The polymer-coated particulate composition of claim 18, wherein the polymer is a water-insoluble polymer.

20. The polymer-coated particulate composition of claim 9, wherein the polymer is selected from a group comprising the binders/encapsulating agents listed in Table 1.

21. The polymer-coated particulate composition of claim 10, wherein the at least one additional material is selected from a group comprising wetting agents, dispersing agents, carriers, and fillers.

22. The polymer-coated particulate composition of claim 21, wherein the at least one additional material is selected from a group comprising dioctyl sodium sulfosuccinate, a lignosulfonate, a naphthalene sulfonate, a 2-[methyl[(9Z)-1-oxo-9-octadecen-1-yl]amino]-ethanesulfonic acid salt, a polypropylene oxide, a polyethylene oxide, a block co-polymer of polypropylene oxide and polyethylene oxide, iron (III) oxide, and a polyurea.

23. A formulation comprising the polymer-coated particulate composition of claim 1.

24. The formulation of claim 23, wherein the formulation is a liquid suspension.

25. The formulation of claim 23, wherein the formulation is selected from the group consisting of a water dispersible granule, a suspension concentrate, and a wettable powder.

26. The formulation of claim 23, further comprising at least one compatible ingredient selected from the group consisting of surfactants, thickeners, dispersants, preservatives, stabilizers, buffers, propylene glycol, self-emulsifiable esters, liquid carriers, fillers, dyes, fragrances, viscosity-lowering additives, freeze-point depressants, and other biologically active compounds.

27. The formulation of claim 23, wherein the formulation is suitable for soil application to a target zone.

28. The formulation of claim 27, wherein the biologically active compound persists longer in the target zone when it is applied than the compound persists when it is applied in a formulation comprising non-polymer coated particles.

29. The formulation of claim 27, wherein the biologically active compound moves more slowly from the target zone when it is applied than the compound moves from the target zone when it is applied in a formulation comprising non-polymer coated particles.

30. A method for producing the polymer-coated particulate composition of claim 1, the method comprising:
providing the biologically active compound in a solid particulate composition; and
adhering a polymer to the solid particulate composition.

31. The method according to claim 30, wherein the biologically active compound is a solid particulate material.

32. The method according to claim 30, wherein the biologically active compound is not a solid material, wherein the solid particulate composition is a composite composition comprising at least one additional material.

33. The method according to claim 30, wherein the solid particulate composition comprises particles that are milled to a particle size of between about 0.1 microns and about 100 microns.

34. The method according to claim 30, wherein adhering the polymer to the solid particulate composition is through a spray-dry process.

35. The method according to claim 34, wherein the spray-dry process comprises mixing the polymer and the solid particulate composition to form a suspension.

36. The method according to claim 35, wherein the spray-dry process further comprises passing the suspension through a spray dryer to produce a powder comprising the biologically active compound and the polymer.

37. The method according to claim 30, wherein the biologically active compound is a pesticide.

38. A method for decreasing the rate at which a biologically active compound disappears from a target zone, comprising applying the polymer-coated particulate composition of claim 1 to the target zone, wherein disappearance of the biologically active compound from the target zone is reduced compared to disappearance of the biologically active compound from the target zone when applied in a non-polymer coated particulate composition.

39. The method according to claim 38, wherein the target zone is a zone of soil with a vertical dimension and a horizontal dimension.

40. The method according to claim 39, wherein the vertical dimension is two inches of soil.

41. A method for increasing the persistence of a biologically active compound in a target zone, comprising applying the polymer-coated particulate composition of claim 1 to the target zone, wherein persistence of the biologically active compound in the target zone is increased compared to persistence of the biologically active compound in the target zone when applied in a non-polymer coated particulate composition.
